(19) United States
(12) Patent Application Publication
(10) Pub. No.: US 2025/0274010 A1
(43) Pub. Date: Aug. 28, 2025

(54) MOTOR ARRANGEMENT WITH SOLENOID

(71) Applicant: Eaton Intelligent Power Limited, Dublin 4, (IE)

(72) Inventors: Ojas R. KULKARNI, Pune (IN); Richard Strong WALLACE, JR., Saint Joseph, MI (US); Saurabh PRAKASH, Prayagraj (IE)

(73) Assignee: Eaton Intelligent Power Limited, Dublin 4, (IE)

(21) Appl. No.: 19/061,311

(22) Filed: Feb. 24, 2025

(30) Foreign Application Priority Data
Feb. 22, 2024 (IN) 202411012620

(51) Int. Cl. H02K 7/12; H02K 7/00; H02K 7/116; H02K 11/00

(52) U.S. Cl. CPC H02K 7/125; H02K 7/003; H02K 7/116; H02K 11/0094

(57) ABSTRACT

A motor arrangement includes a solenoid disposed within a cavity of the motor stator. The solenoid is configured to axially move the motor shaft arrangement. In certain examples, the solenoid causes the motor shaft arrangement to selectively engage a torque limiting arrangement or other device. The motor shaft arrangement may be biased into engagement with the device.

### CROSS-REFERENCE TO RELATED APPLICATIONS

This application claims the benefit of Indian application Ser. No. 20/241,1012620, filed Feb. 22, 2024, and titled “MOTOR ARRANGEMENT WITH SOLENOID,” the disclosure of which is hereby incorporated herein by reference in its entirety.

### BACKGROUND

More-electric aircraft and all-electric aircraft are increasingly becoming more relevant in the aerospace industry. Although actuators in aircraft control mechanisms have conventionally been hydraulic/mechanical systems, electrical drive systems (EDS) including an electric motor and an electric drive are gaining interest in aerospace applications due to growing demands for more/all-electric aircrafts. In some implementations, a flight control actuation system using electric motors and drives can be used to move the aircraft flight control surfaces to respective commanded positions. Typical flight control surfaces include ailerons, flaps, slats, and spoilers. In some implementations, an external brake assembly is provided to lock the position of the motor, such as a solenoid-type brake attached to the motor shaft. Motor applications with external braking systems exist in other industries as well. Improvements are desired.

### SUMMARY

Some aspects of the disclosure are directed to a motor disposed within a motor housing, the motor including a motor stator and a motor rotor; a motor shaft that is axially movable relative to the motor housing between a first position and a second position; a biasing member biasing the motor shaft towards the first position; a magnetizable solenoid plunger axially fixed relative to the motor shaft so that the solenoid plunger moves in unison with the motor shaft between the first and second positions; and a solenoid coil disposed within the motor housing in at least partial radial alignment with the motor stator.

In certain implementations, a device is disposed within the motor housing at a location axially offset along the longitudinal axis from the motor stator; and a force transfer member is coupled to the motor shaft to move axially in unison with the motor shaft between the first and second positions. The force transfer member is configured to engage the device when the motor shaft is disposed in the first position. The force transfer member is spaced from the device when the motor shaft is disposed in the second position. In certain examples, the device includes a torque limiting member.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of an example motor arrangement configured in accordance with the principles of the present disclosure;

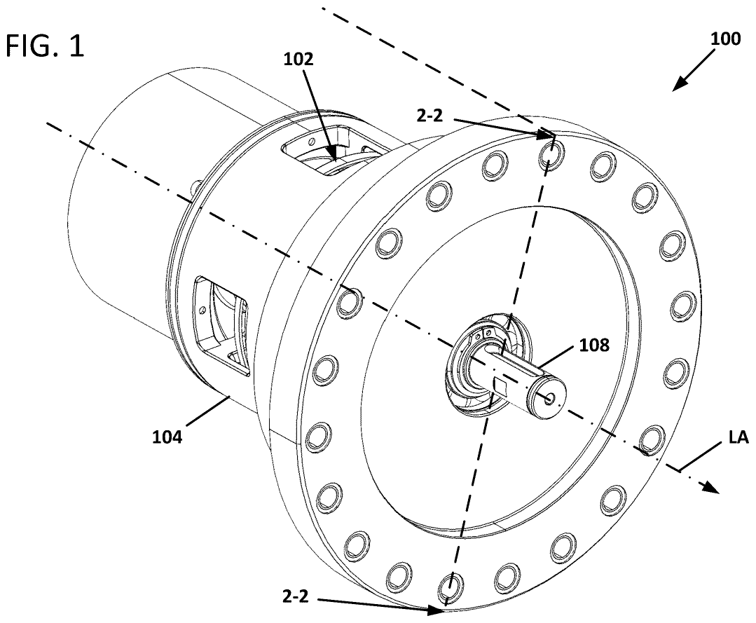

FIG. 2 is a cross-sectional view of the motor arrangement of FIG. 1 taken along the 2-2 line of FIG. 1, where a motor shaft arrangement is shown in a first axial position;

FIG. 3 shows the motor shaft arrangement of FIG. 2 in a second axial position;

FIG. 4 is a schematic diagram of portions of the motor arrangement of FIG. 2; and

FIG. 5 is a schematic diagram of portions of the motor arrangement of FIG. 3.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

A motor arrangement 100 includes a motor 104 disposed within a motor housing 102. The motor housing 102 has a longitudinal axis LA. A motor shaft arrangement 106 is disposed at least partially within the motor housing 102 and operationally couples to an output shaft 108. In some examples, the motor shaft arrangement 106 and/or the output shaft 108 are coaxial with the longitudinal axis LA. In other examples, the motor shaft arrangement 106 and/or the output shaft 108 are parallel with the longitudinal axis LA. The motor 104 includes a motor stator 110 that is stationary relative to the motor housing 102 and a motor rotor 112 that rotates relative to the motor stator 110. In certain examples, the motor rotor 112 rotates about the longitudinal axis LA of the motor housing 102. In certain implementations, the motor rotor 112 also is rotationally fixed relative to the motor shaft arrangement 106 so that the motor shaft arrangement 106 rotates in unison with the motor rotor 112.

In certain implementations, the motor rotor 112 carries one or more magnets 114. In such implementations, the motor stator 110 includes a stator coil 116 that, when energized, creates an electromagnetic field that interacts with the magnets 114 to induce rotation of the motor rotor 112. In certain examples, the motor rotor 112 has a cup-shape that surrounds the motor stator 110 with the magnets 114 facing towards the motor stator 110. In certain implementations, a first controller 120 (e.g., an electromagnetic controller) manages energization of the stator coil 116.

The motor rotor 112 is coupled to the motor shaft arrangement 106 to rotate in unison therewith. In certain implementations, the motor shaft arrangement 106 includes a motor shaft 132 to which the motor rotor 112 may be splined or otherwise connected with an interference fit. In some implementations, the motor shaft arrangement 106 includes a force transfer member 118 that rotates in unison with the motor shaft 132. In certain examples, the force transfer member 118 is splined or otherwise connected to the motor shaft 132 with an interference fit. In certain examples, the force transfer member 118 is configured to transfer the torque between the motor shaft 132 and the output shaft 108. In other implementations, the force transfer arrangement 118 is directly coupled to the motor rotor 112. In certain examples, the force transfer member 118 is configured to transfer the torque between the motor rotor 112 and the output shaft 108. For example, the force transfer member 118 may be fastened (e.g., bolted) to the motor rotor 112 and splined to the output shaft 108. In still other implementations, the force transfer member 118 is directly coupled to both the motor shaft arrangement 106 and the motor rotor 112.

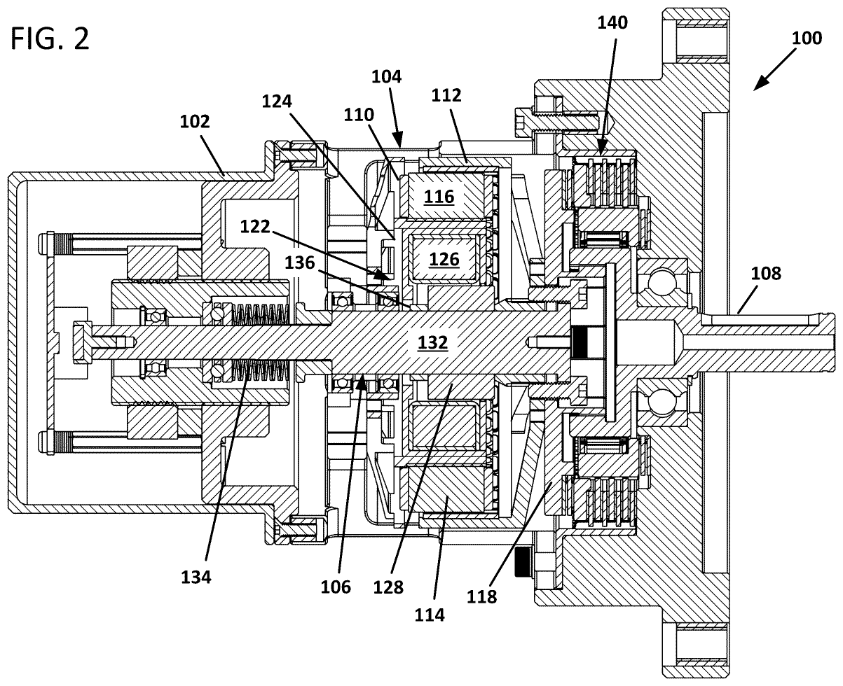

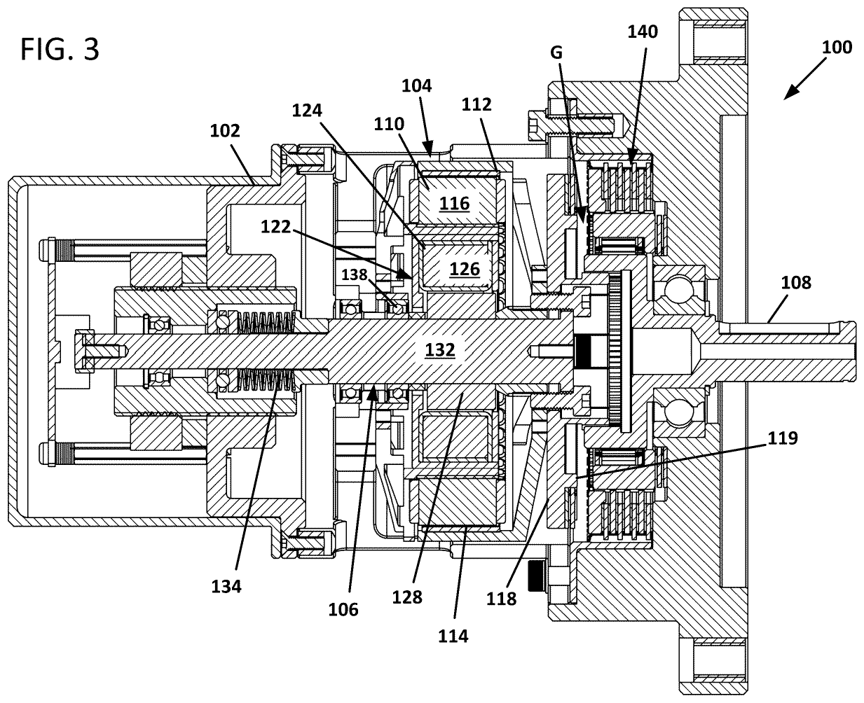

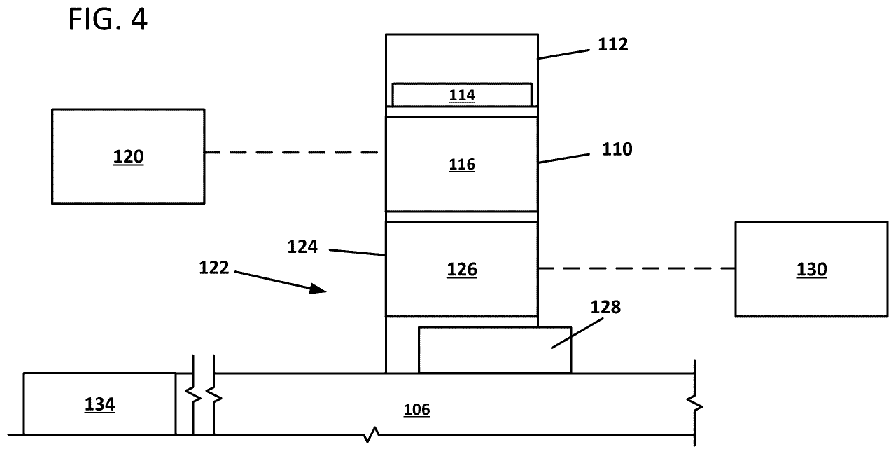

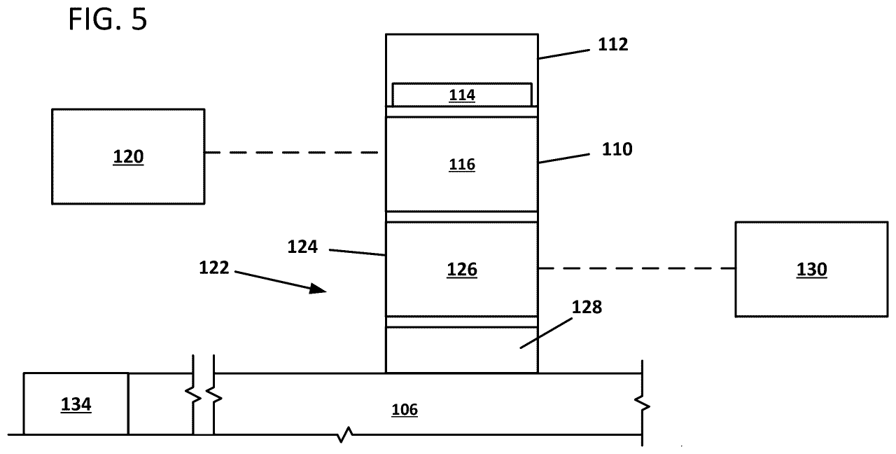

In accordance with certain aspects of the disclosure, a solenoid arrangement 122 is disposed within the motor housing 102 to axially shift the motor shaft arrangement 106 relative to the motor housing 102. As will be described herein, axially moving the motor shaft arrangement 106 enables selective engagement to and disengagement from one or more devices 140, such as a torque limiting arrangement or a clutch. For example, in certain implementations, the motor shaft arrangement 106 is slid or otherwise axially moved between first and second positions. The device 140 is engaged when the motor shaft arrangement 106 is disposed in the first position (e.g., see FIGS. 2 and 4) whereas the device 140 is disengaged when the motor shaft arrangement 106 is disposed in the second position (e.g., see FIGS. 3 and 5).

The device 140 is disposed within the motor housing 102. In certain implementations, when the motor shaft 106 is disposed in the first position, the force transfer member 118 is engaged with the device 140. In an example where the device 140 is a torque limiting member, the device 140 inhibits rotation of the force transfer member 118, thereby limiting rotation of the motor shaft 106, motor rotor 112, and output shaft 108. When the solenoid arrangement 122 moves the output shaft arrangement 106 to the second position, the force transfer member 118 is pulled out of engagement with the device 140. For example, the force transfer member 118 is spaced from the device 140 by a gap G. In the example where the device 140 is a torque limiting member, the force transfer member 118, motor shaft arrangement 106, motor rotor 112, and output shaft 108 can rotate freely relative to the motor housing 102 when the output shaft arrangement 106 is disposed in the second position.

In certain implementations, the motor shaft arrangement 106 is biased towards the first position using a biasing member 134. In certain examples, the biasing member 134 is disposed at a location axially offset along the motor shaft 132 from the motor stator 110 and motor rotor 112. In certain examples, the biasing member 134 is a spring. In an example, the biasing member 134 is a Belleville spring. In an example, the biasing member 134 includes a plurality of wave discs. The solenoid arrangement 122 selectively overcomes the bias of the biasing member 134 to move the motor shaft arrangement 108 towards the second position as will be discussed in more detail herein.

In certain implementations, the solenoid 122 includes solenoid coil 126 configured to be selectively energized and a solenoid plunger 128 configured to be influenced by the resulting electromagnetic field. In some examples, the solenoid plunger 128 is formed of a ferrous or other magnetizable material. In other examples, a coating, insert, or other portion of the solenoid plunger 128 is ferrous or otherwise magnetizable. In certain implementations, a second controller 130 (e.g., an electromagnetic controller) manages energization of the solenoid coil 126. The second controller 130 can function independent of the first controller 120. Accordingly, rotation of the motor shaft arrangement 106 and axial movement of the motor shaft arrangement 106 are separately and independently controllable.

In accordance with certain aspects of the disclosure, the solenoid coil 126 is disposed within a central cavity of the motor stator 110. In an example, the solenoid coil 126 is disposed within a solenoid housing 124. The motor shaft 132 of the motor shaft arrangement 106 extends through the solenoid coil 126 and moves relative thereto. In certain examples, the solenoid coil 126 is disposed in radial alignment with the stator coil 116. In certain examples, the solenoid housing 124 does not extend outwardly beyond the motor stator 110.

When the solenoid coil 126 is energized, the solenoid plunger 128 is influenced by the resulting electromagnetic field to move further into alignment with the coil 126. The solenoid plunger 128 is axially fixed relative to the motor shaft arrangement 106 (e.g., with an interference fit with the motor shaft 132). Accordingly, energizing the solenoid coil 126 pulls on the solenoid plug 128, thereby moving the motor shaft arrangement 106 towards the second position against the bias of the biasing member 134. In certain examples, the magnets 114 of the motor rotor 112 exert a pull on the solenoid plunger 128, but with insufficient force to overcome the biasing member 134. In such examples, energizing the solenoid coil 126 supplements the force exerted by the magnets 114 to overcome the biasing force of the biasing member 134 and axially move the solenoid plunger 128 into further alignment with the magnets 114 and solenoid coil 126.

In certain implementations, a stop 136 may be disposed at the motor shaft arrangement 106 to limit axial movement of the solenoid plunger 128 (e.g., to stop the axial movement at the second position of the motor shaft arrangement 106). In some examples, the stop 136 is axially fixed to the motor shaft 132 of the motor shaft arrangement 106. In certain examples, the stop 136 also is rotationally fixed to motor shaft 132. As shown in FIG. 3, the stop 136 engages a component within the motor housing 102 (e.g., a bearing arrangement 138) when the motor shaft arrangement 106 is disposed in the second position. In certain examples, the stop 136 is a sleeve configured to protect the solenoid plunger 128 from wear and tear against the bearing arrangement 138 or other component.

In some implementations, axial travel of the motor shaft arrangement 106 towards the first position is limited by the engagement between the force transfer member 118 and the device 140. In other implementations, the force transfer member 118 includes one or more stops 119 configured to abut a housing of the device 140 or other axially-fixed component within the motor housing 102. The one or more stops 119 limit the amount of force the force transfer member 118 can exert on the device 140.

### Example Aspects

Aspect 1. A motor arrangement comprising: a motor housing having a longitudinal axis; a motor disposed within the motor housing, the motor including a motor stator and a motor rotor; a motor shaft disposed within the motor housing and extending through the motor stator along the longitudinal axis of the motor housing, the motor shaft being axially movable relative to the motor housing along the longitudinal axis between a first position and a second position; a biasing member biasing the motor shaft towards the first position; a solenoid plunger axially fixed relative to the motor shaft so that the solenoid plunger moves in unison with the motor shaft between the first and second positions, the solenoid plunger being formed of magnetic material; and a solenoid coil disposed within the motor housing in at least partial radial alignment with the motor stator, the solenoid coil being configured to move the solenoid plunger towards the second position against the bias of the biasing member when energized.

Aspect 2. The motor arrangement of aspect 1, further comprising: a component disposed within the motor housing at a location axially offset along the longitudinal axis from the motor stator; and a force transfer member coupled to the motor shaft to move axially in unison with the motor shaft between the first and second positions, the force transfer member being configured to engage the component when the motor shaft is disposed in the first position, the force transfer member being spaced from the component when the motor shaft is disposed in the second position.

Aspect 3. The motor arrangement of aspect 2, wherein the component includes a torque limiting arrangement.

Aspect 4. The motor arrangement of aspect 3, wherein the torque limiting arrangement includes a plurality of lamella disposed between two thrust bearings.

Aspect 5. The motor arrangement of aspect 2, further comprising an output shaft extending out of the motor housing, the output shaft being operationally coupled to the motor shaft through the force transfer member.

Aspect 6. The motor arrangement of aspect 5, wherein the force transfer member is splined to the output shaft.

Aspect 7. The motor arrangement of aspect 2, wherein the force transfer member is rotationally fixed to the motor rotor.

Aspect 8. The motor arrangement of aspect 1, wherein the motor rotor includes a cup-style rotor at least partially surrounding the motor stator, the motor rotor carrying a plurality of magnets.

Aspect 9. The motor arrangement of aspect 1, wherein the motor stator has a ring-shape and defines a central passage; and wherein the solenoid coil is disposed within the central passage.

Aspect 10. The motor arrangement of aspect 9, wherein the solenoid plunger is at least partially rotationally aligned with the solenoid coil when disposed in the second position.

Aspect 11. The motor arrangement of aspect 1, further comprising a first stop that inhibits movement of the motor shaft beyond the first position.

Aspect 12. The motor arrangement of aspect 11, further comprising a second stop that inhibits movement of the motor shaft beyond the second position.

Aspect 13. The motor arrangement of aspect 1, wherein the biasing member includes a Belleville spring.

Aspect 14. The motor arrangement of aspect 1, wherein the solenoid plunger is mounted to the motor shaft with an interference fit.

Aspect 15. The motor arrangement of aspect 1, wherein the solenoid plunger is threaded onto the motor shaft.

Aspect 16. The motor arrangement of aspect 1, wherein the solenoid plunger is at least partially disposed within the solenoid coil and the solenoid coil is at least partially disposed within the motor stator.

Aspect 17. The motor arrangement of aspect 16, wherein the motor stator is at least partially disposed within the motor rotor.

Aspect 18. The motor arrangement of aspect 1, wherein the solenoid plunger is a sleeve mounted about the motor shaft.

Aspect 19. The motor arrangement of aspect 1, further comprising a first controller configured to manage energization of the solenoid coils to control axial movement of the solenoid plunger.

Aspect 20. The motor arrangement of aspect 19, further comprising a second controller configured to manage energization of the motor stator to control rotation of the motor rotor, the second controller operating independent of the first controller.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A motor arrangement comprising:
a motor housing having a longitudinal axis;
a motor disposed within the motor housing, the motor including a motor stator and a motor rotor;
a motor shaft disposed within the motor housing and extending through the motor stator along the longitudinal axis of the motor housing, the motor shaft being axially movable relative to the motor housing along the longitudinal axis between a first position and a second position;
a biasing member biasing the motor shaft towards the first position;
a solenoid plunger axially fixed relative to the motor shaft so that the solenoid plunger moves in unison with the motor shaft between the first and second positions, the solenoid plunger being formed of magnetic material; and
a solenoid coil disposed within the motor housing in at least partial radial alignment with the motor stator, the solenoid coil being configured to move the solenoid plunger towards the second position against the bias of the biasing member when energized.

2. The motor arrangement of claim 1, further comprising:
a component disposed within the motor housing at a location axially offset along the longitudinal axis from the motor stator; and
a force transfer member coupled to the motor shaft to move axially in unison with the motor shaft between the first and second positions, the force transfer member being configured to engage the component when the motor shaft is disposed in the first position, the force transfer member being spaced from the component when the motor shaft is disposed in the second position.

3. The motor arrangement of claim 2, wherein the component includes a torque limiting arrangement.

4. The motor arrangement of claim 3, wherein the torque limiting arrangement includes a plurality of lamella disposed between two thrust bearings.

5. The motor arrangement of claim 2, further comprising an output shaft extending out of the motor housing, the output shaft being operationally coupled to the motor shaft through the force transfer member.

6. The motor arrangement of claim 5, wherein the force transfer member is splined to the output shaft.

7. The motor arrangement of claim 2, wherein the force transfer member is rotationally fixed to the motor rotor.

8. The motor arrangement of claim 1, wherein the motor rotor includes a cup-style rotor at least partially surrounding the motor stator, the motor rotor carrying a plurality of magnets.

9. The motor arrangement of claim 1, wherein the motor stator has a ring-shape and defines a central passage; and wherein the solenoid coil is disposed within the central passage.

10. The motor arrangement of claim 9, wherein the solenoid plunger is at least partially rotationally aligned with the solenoid coil when disposed in the second position.

11. The motor arrangement of claim 1, further comprising a first stop that inhibits movement of the motor shaft beyond the first position.

12. The motor arrangement of claim 11, further comprising a second stop that inhibits movement of the motor shaft beyond the second position.

13. The motor arrangement of claim 1, wherein the biasing member includes a Belleville spring.

14. The motor arrangement of claim 1, wherein the solenoid plunger is mounted to the motor shaft with an interference fit.

15. The motor arrangement of claim 1, wherein the solenoid plunger is threaded onto the motor shaft.

16. The motor arrangement of claim 1, wherein the solenoid plunger is at least partially disposed within the solenoid coil and the solenoid coil is at least partially disposed within the motor stator.

17. The motor arrangement of claim 16, wherein the motor stator is at least partially disposed within the motor rotor.

18. The motor arrangement of claim 1, wherein the solenoid plunger is a sleeve mounted about the motor shaft.

19. The motor arrangement of claim 1, further comprising a first controller configured to manage energization of the solenoid coils to control axial movement of the solenoid plunger.

20. The motor arrangement of claim 19, further comprising a second controller configured to manage energization of the motor stator to control rotation of the motor rotor, the second controller operating independent of the first controller.
